(19) United States
(12) Patent Application Publication
(10) Pub. No.: US 2024/0178755 A1
(43) Pub. Date: May 30, 2024

(54) FAST RECOVERY RESPONSE TO LOAD DUMPS IN A POWER CONVERTER SYSTEM

(71) Applicant: Infineon Technologies AG, Neubiberg (DE)

(72) Inventor: Luca Scandola, Villafranca di Verona (IT)

(21) Appl. No.: 18/058,829

(22) Filed: Nov. 25, 2022

(51) Int. Cl. H02M 3/158; H02M 1/00; H02M 3/157

(52) U.S. Cl. CPC H02M 3/158; H02M 1/0009; H02M 1/0058; H02M 3/157

(57) ABSTRACT

This disclosure describes techniques for controlling a power converter, such as a closed loop synchronous buck converter that implements a low side switch as a so-called active diode. According to this disclosure, in response to a load dump event in which current from an LC circuit causes a negative load dump current at the power converter, the system may be configured operate in a forced continuous conduction mode (CCM) for a period of time associated with the load dump event, after operating in a normal CCM, and prior to operating in a discontinuous conduction mode (DCM). Unlike normal CCM mode where current is always positive on the power converter, in the forced CCM, current on the power converter is allowed to go negative, in order to dissipate the load event in a quick and effective manner.

### TECHNICAL FIELD

This disclosure relates to power electronics, and more specifically to power converter systems and control circuits that control operation of power converter systems.

### BACKGROUND

In many systems, power converters are used to control voltage and/or current levels within the system. Power converters may comprise direct current (DC)/DC buck converters, DC/DC boost converters, DC/DC buck/boost converters, or other types. Some buck converters, for example, may comprise an LC circuit that is connected to a switch node, where the switch node is positioned between a high side power switch and a low side power switch. The high side and low side power switches are controlled by driver circuits via modulation control signals, such as pulse width modulation (PWM) signals, pulse frequency modulation (PFM) signals, pulse duration modulation signals, pulse density modulation signals, or another type of modulation control signal.

In particular, a controller and/or a gate driver can deliver modulation control signals to the gates of the high side and low side power switches to control the on/off switching of the power switches. In some examples, logic in the controller delivers control signals to the driver(s), and the driver(s) generate and deliver higher-power driving signals to the control terminals of the power switches. By controlling the on/off switching of the power switches, the controller can effectively control the delivery of power to the switch node that is located between the high side switch and the low side switch that form a half bridge. In this way, by controlling the high side and low side switches of a DC/DC converter, the controller can cause a desired level of current and voltage to be output from the DC/DC converter in order to provide power to a load or another component of the system.

Some loads have specific regulation targets for DC/DC converters, which can be challenging to satisfy. For example, some microcontrollers or other electronic circuits or devices may demand very tight voltage regulation while delivering relatively high amperage to the load. Meeting such demands can be challenging for DC/DC power converter systems.

### SUMMARY

This disclosure describes power converter systems, circuits for controlling power converter systems, and methods for controlling a power converter system that can satisfy very tight voltage regulation while delivering relatively high amperage to the load. The circuits, systems, and techniques of this disclosure may be especially useful to handle load dump situations, e.g., where the current demand at the load changes and cause an inductor-capacitor (LC) to deliver a load dump back to the DC/DC power converter system. These events may cause some DC/DC power converter system to operate out of the desired regulation, causing undesirable voltage overshoot and/or voltage undershoot of the regulation targets. To address such load dump situations, the systems, devices, and techniques of this disclosure may operate power switches of a power converter system in a way that deviates from a normal control scheme of the power switches.

According to this disclosure, in a normal control scheme, a high side power switch and a low side power switch of a power converter system may be configured to operate in a continuous conduction mode (CCM) and in a discontinuous conduction mode (DCM). However, in response to a load dump event in which current from an LC circuit causes a negative load dump current at the power converter, the system may be configured operate in a forced CCM for a period of time associated with the load dump event, after operating the CCM, and prior to operating in the DCM. Unlike regular CCM mode where current is always positive on the power converter, in the forced CCM, current on the power converter is allowed to go negative, in order to dissipate the load event in a quick and effective manner.

In some examples, this disclosure describes a power converter system comprising: a high side power switch; a low side power switch connected to the high side power switch at a switch node; an LC circuit connected to the switch node; and a detector connected to a low side of the low side power switch. The power converter system also includes control logic configured to control the high side power switch and the low side power switch according to a control scheme in which the power converter system is configured to operate in a CCM in response to determining a positive current on the low side of the low side power switch and operate in a DCM in response to determining a negative current on the low side of the low side power switch. Moreover, in response to a load dump event in which current from the LC circuit causes a negative load dump current at the detector, the control logic is further configured to control the high side power switch and the low side power switch such that the power converter system is configured to operate in a forced CCM for a period of time associated with the load dump event prior to operating in the DCM.

In some examples, this disclosure describes a circuit configured to control a power converter system that includes a high side power switch, a low side power switch connected to the high side power switch at a switch node, an LC circuit connected to the switch node, and a detector connected to a low side of the low side power switch. The circuit comprises control logic configured to control the high side power switch and the low side power switch according to a normal scheme in which the power converter system is configured to operate in a CCM in response to determining a positive current on the low side of the low side power switch and operate in a DCM in response to determining a negative current on the low side of the low side power switch, wherein in response to a load dump event in which current from the LC circuit causes a negative load dump current at the detector, the control logic is further configured to control the high side power switch and the low side power switch such that the power converter system is configured to operate in a forced CCM for a period of time associated with the load dump event prior to operating in the DCM.

In some examples, this disclosure describes method of controlling a power converter system that includes a high side power switch, a low side power switch connected to the high side power switch at a switch node, an LC circuit connected to the switch node, and a detector connected to a low side of the low side power switch. The method may comprise controlling the high side power switch and the low side power switch according to a control scheme such that the power converter system is configured to operate in a CCM in response to determining a positive current on the low side of the low side power switch; controlling the high side power switch and the low side power switch according to the control scheme such that the power converter system is configured to operate in a DCM in response to determining a negative current on the low side of the low side power switch; and in response to a load dump event in which current from the LC circuit causes a negative load dump current at the detector, controlling the high side power switch and the low side power switch such that the power converter is configured to operate in a forced CCM for a period of time associated with the load dump event prior to operating in the DCM.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block and circuit diagram of an example power converter system, in accordance with this disclosure.

FIG. 2 is another block and circuit diagram of an example power converter system connected to a microcontroller, in accordance with this disclosure.

FIG. 3 is a set of graphs showing a load dump that may cause a regulation failure and high voltage undershoot, which the techniques of this disclosure may improve.

FIG. 4 is a set of graphs showing how a forced CCM according to this disclosure can improve upon the regulation failure and high voltage undershoot shown in FIG. 3.

FIGS. 5A and 5B are flow diagrams showing a technique without a forced CCM (FIG. 5A) and a technique with a forced CCM (FIG. 5B).

FIG. 6 is another set of graphs showing another example of a forced CCM according to this disclosure that can improve upon the regulation failure and high voltage undershoot shown in FIG. 3.

FIG. 7 is a flow diagram showing another technique consistent with this disclosure.

FIG. 8 is a circuit diagram showing some example logic consistent with this disclosure.

FIG. 9 is another circuit diagram showing example logic consistent with this disclosure.

FIG. 10 is a circuit diagram showing an example analog circuit consistent with this disclosure.

FIG. 11 is another set of graphs showing another example of a forced CCM according to an analog example of this disclosure that can improve upon the regulation failure and high voltage undershoot shown in FIG. 3.

FIG. 12 is another block and circuit diagram of an example power converter system connected to a microcontroller, in accordance with this disclosure.

FIG. 13 is a flow diagram consistent with one or more techniques of this disclosure.

FIGS. 14 and 15 are conceptual graphs showing some alternative examples of LC current during a forced CCM where current is LC current is allowed to go negative.

FIG. 16 is a depiction of an example error amplifier, which may be used in the circuit of FIG. 12.

### DETAILED DESCRIPTION

This disclosure describes power converter systems, circuits for controlling power converter systems, and methods for controlling a power converter system that can satisfy very tight voltage regulation while delivering relatively high amperage to the load. In some examples, the circuits and systems can regulate a voltage and a current to between approximately 0.7 and 1.2 volts with output current greater than approximately 5 amps at a switch node of a power converter, although the systems and circuits are not limited to these voltage and current ranges. Such regulation is desirable for some microcontrollers and may also be desirable for a wide range of other circuits, devices, or loads.

The techniques may be especially useful to handle load dump situations, e.g., where the current demand at the load changes and causes an inductor-capacitor (LC) to deliver a load dump back to the DC/DC power converter system. These events may cause some DC/DC power converter systems to operate out of the desired regulation, causing undesirable voltage overshoot and/or voltage undershoot of the regulation targets. To address such load dump situations, the systems, devices, and techniques of this disclosure may operate power switches of a power converter system in a way that deviates from a normal control scheme of the power switches.

According to this disclosure, in a normal control scheme, a high side power switch and a low side power switch of a power converter system may be configured to operate in a continuous conduction mode (CCM) and in a discontinuous conduction mode (DCM). Operating in both CCM and DCM can make closed loop synchronous buck converters more efficient relative to power converters that use a normal diode on the low side. Closed loop synchronous buck converters that implement a low side switch as a so-called active diode, in particular, may have normal operation that switches from CCM to DCM when zero current is detected on the power converter, to achieve better efficiency by avoiding conduction losses.

However, according to this disclosure, in response to a load dump event in which current from an LC circuit causes a negative load dump current at the power converter, the system may be configured operate in a forced CCM for a period of time associated with the load dump event, after operating the CCM, and prior to operating in the DCM. Unlike regular CCM mode where current is always positive on the power converter, in the forced CCM, current on the power converter is allowed to go negative, in order to dissipate the load event in a quick and effective manner.

Some new generations of microcontrollers demand low voltage rails (e.g., around 1 Volt) and high current (e.g., up to 7 Amps or higher). Moreover, some of these microcontrollers may demand 2% static accuracy 4% dynamic accuracy. Failing to meet these requirements can impact safety and functionality. In some cases, only few tens of millivolts are accepted as under voltages or under during load steps. Furthermore, for some safety applications, a monitoring circuit may also check if the output voltage is between safe thresholds, and the monitoring circuit may trigger a safety mechanism if the voltage is below or above the targets.

One challenging situation is a so-called “load dump” at the power converter. A load dump refers to a situation where the current demand at the load changes and causes an LC to deliver a load dump back to the power converter system. These events may cause some power converter systems to operate out of the desired regulation, causing undesirable voltage overshoot and/or voltage undershoot of the regulation targets. In the example where the power converter is connected to a microcontroller, load dumps can be caused when the microcontroller goes into a standby mode, or situations where some microcontroller modules are turned off. Similar situations may also occur with power converters used with other devices or loads when the current demand is reduced.

In various examples, a power converter architecture consistent with this disclosure may be based on a closed loop synchronous buck converter with an active diode. The active diode comprises a low side switch with a zero current detector (ZCD) that turns the low side power switch off if the current goes to zero. Active diodes are desirable instead of standard diodes to achieve better efficiency in closed loop synchronous buck converters, whereby conduction losses are reduced relative to converters that use a regular diode on the low side.

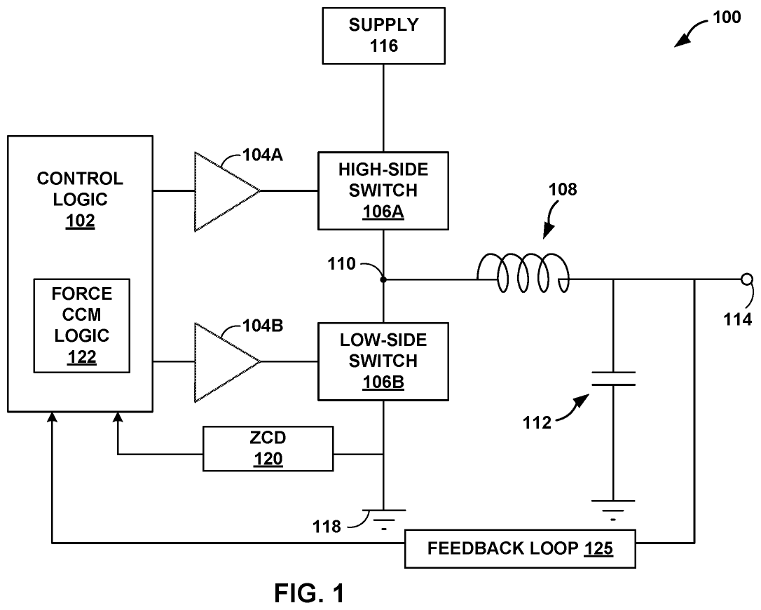

FIG. 1 is a block and circuit diagram of an example power converter system, in accordance with this disclosure. In the example shown in FIG. 1, power converter system 100 is configured as a buck converter that includes high side switch 106A coupled to low side switch 106B and inductor 108 at node 110. Node 110 is referred to as a so-called “switch node.” Each of switches 106A and 106B may include a diode that is coupled in parallel with a conductive path of the respective switch. In some examples, switches 106A and 106B may each comprise a metal oxide semiconductor field effect transistor (MOSFET), and the diodes may comprise the body diodes of the MOSFETs.

Drivers 104A and 104B may be configured to drive switches 106A and 106B. In various examples, each of drivers 104A and 104B may be standalone components, or drivers 104A and 104B may be combined into a single device, or drivers 104A, 104B may be integrated into a controller in combination with control logic 102. Also, in various examples, switches 106A and 106B may comprise an N-type metal-oxide-semiconductor (MOS) device, a P-type MOS device, a bipolar junction transistor device, a junction field effect transistor (FET) device, a MOSFET device, an insulated-gate bipolar transistor device, or another device type. Switches 106A and 106B may comprise semiconductor material such as silicon, germanium, silicon carbide, and/or gallium nitride.

During operation, controller 102 may be configured to generate pulse modulation (PM) control signals, such as pulse-width modulation (PWM) signals, pulse density modulation signals, pulse duration modulation signals, or pulse frequency modulation (PFM) signals to drivers 104A and 104B, and drivers 104A and 104B may generate PM drive signals (e.g., PM gate signals) to control the ON/OFF (e.g., activation/deactivation) state of switches 106A and 106B based on the PM control signals. In this way, controller 102 may be configured to control switches 106A and 106B to couple and decouple switch node 110 to supply node 116 or reference node 118.

When switch 106A is activated and switch 106B is deactivated, current flows from supply node 116 though switch node 110 and inductor 108 to charge capacitor 112. When switch 106A is deactivated and switch 106B is activated in normal operation, current continues to flow through the inductor 108. Inductor 108 and capacitor 112 form an LC circuit, which is connected to switch node 110 and a load at node 114. A feedback loop 125 defines a normal regulation loop so that control logic 102 can ensure that the proper control signals are sent to switches 106A and 106B, depending on the output at node 114. A ZCD 120 may be configured to detect a zero-crossing event on the low side of low side switch 106B, and control logic 102 may be configured to respond to ZCD 120, e.g., to cause a change from CCM to another mode. In general, ZCD 120 is one example of a detector configured to identify zero current events. The zero current events may determine either positive current or the negative current at the low side of low side power switch 106B.

According to this disclosure, control logic 102 may comprise a circuit configured to control power converter system 100, which includes high side power switch 106A, low side power switch 106B connected to high side power switch 106A at a switch node 110, an inductor-capacitor (LC) circuit (108 and 112) connected to switch node 110, and a detector (e.g., ZDC 120) connected to a low side of low side power switch 106B. Control logic 102 may be configured to control the high side power switch 106A and low side power switch 106B according to a normal control scheme in which power converter system 100 is configured to operate in a CCM when ZCD 120 determines a positive current on the low side of low side power switch 106B and operate in a DCM when ZCD 120 determines a negative current on the low side of the low side power switch. For example, ZCD 120 may be configured to identify zero current events, wherein the zero current events are used to determine the positive current or the negative current at the low side of the low side power switch. LC current generally trends upward or downward, and therefore, if current is known to be positive, then a zero current detection event may be indicative of negative current, and if current is known to be negative, the a zero current detection event may be indicative of positive current. In this way, ZCD 120 can be configured to detect positive current or negative current on the low side of the low side power switch via the detection of zero crossing events.

According to this disclosure, control logic 102 includes a force CCM logic 122. In a normal control scheme of power converter system 100 that operates low side switch 106B as an active diode, ZCD 120 may detect zero crossing events, and in response to zero crossing events, control logic 102 may change operation from CCM to DCM to achieve better efficiency. However, according to this disclosure, CCM logic 122 may cause control logic 102 to operate outside of the normal control scheme and in response to a load dump event in which current from the LC circuit (e.g., current on inductor 108 of the LC circuit that includes inductor 108 and capacitor 112) causes a negative load dump current that is detectable by ZCD 120. Force CCM logic 122 is configured to control high side power switch 106A and low side power switch 106B such that the power converter system 100 is configured to operate in a forced CCM for a period of time associated with the load dump event prior to operating in the DCM. Unlike the normal control scheme, in forced CCM mode, current is allowed to go negative at ZCD 120 for a period of time sufficient to dissipate the load dump.

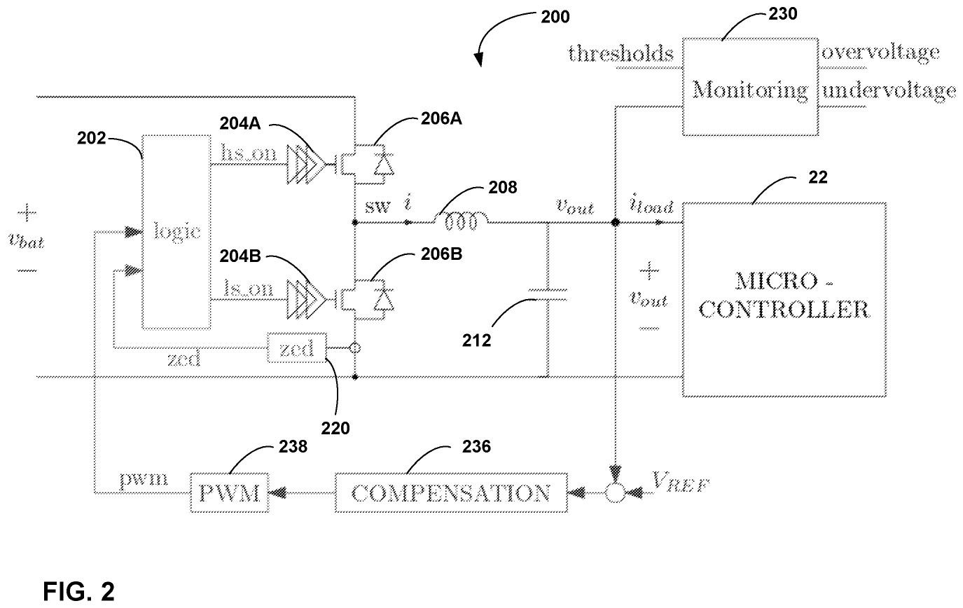

FIG. 2 is another block and circuit diagram of an example power converter system 200, in accordance with this disclosure. In this example, power converter system 200 is connected to a micro-controller 22 at the switch node (SW) and a reference node at the low side of low side power switch 206B. In the example shown in FIG. 2, power converter system 200 is configured as a closed loop synchronous buck converter with an active diode. Power converter system 200 includes high side switch 206A coupled to low side switch 206B and inductor 208 at switch node (SW). Each of switches 206A and 206B may include a diode that is coupled in parallel with conductive path of the respective switch. In some examples, switches 206A and 206B may each comprise a MOSFET, and the diodes of switches 206A, 206B may comprise the body diodes of the MOSFETs.

Drivers 204A and 204B may be configured to drive switches 206A and 206B. In various examples, each of drivers 204A and 204B may be standalone components, or drivers 204A and 204B may be combined into a single device, or drivers 204A, 2104B may be integrated into a controller with logic 202. In various examples, switches 206A and 206B may comprise an N-type metal-oxide-semiconductor (MOS) device, a P-type MOS device, a bipolar junction transistor device, a junction field effect transistor (FET) device, a MOSFET device, an insulated-gate bipolar transistor device, or another device type. Switches 206A and 206B may comprise semiconductor material such as silicon, germanium, silicon carbide, and/or gallium nitride.

During operation, logic 202 may be configured to generate PM control signals, such as PWM signals, pulse density modulation signals, pulse duration modulation signals, or PFM signals to drivers 204A and 204B, and drivers 204A and 204B may generate PM drive signals (e.g., PM gate signals) to control the ON/OFF (e.g., activation/deactivation) state of switches 206A and 206B based on the PM control signals. In this way, logic 202 may be configured to control switches 206A and 206B to couple and decouple switch node (SW) to a supply node on the high side of switch 206A or a reference node on the low side of switch 206B.

When switch 206A is activated and switch 206B is deactivated, current flows from the high side though the switch node (SW) and inductor 208 to charge capacitor 212. When switch 206A is deactivated and switch 206B is activated in normal operation, current continues to flow through the inductor 208. Inductor 208 and capacitor 212 form an LC circuit, which is connected to the switch node (SW) and microcontroller 20.

A feedback loop is defined based on monitored voltages at monitoring circuit 230. The monitored voltages are compared to thresholds to determine if the monitored voltage is too high (i.e., and overvoltage) or too low (i.e., an under voltage). Compensation circuit 236 may cause a PWM generator 238 to generate different PWM signals based on any adjustments relative to a voltage reference (Vref) which may define the target for the regulated voltage. This feedback loop may define a normal regulation loop so that logic 202 can ensure that the proper control signals are sent to switches 206A and 206B, depending on the output at the switch node (SW). A ZCD 220 may be configured to detect a zero-crossing event on the low side of low side switch 206B, and logic 202 may be configured to respond to ZCD 220, e.g., to cause a change from CCM to another mode.

According to this disclosure, logic 202 may comprise a circuit configured to control power converter system 200, which again, includes high side power switch 206A, low side power switch 206B connected to high side power switch 206A at a switch node (SW), an LC circuit (e.g., inductor 208 and capacitor 212) connected to switch node (SW), and a detector (e.g., ZDC 220) connected to a low side of low side power switch 206B. Logic 202 may be configured to control the high side power switch 206A and low side power switch 206B according to a control scheme in which power converter system 200 is configured to operate in a CCM when ZCD 220 determines a positive current on the low side of low side power switch 206B and operate in a DCM when ZCD 220 determines a negative current on the low side of the low side power switch. For example, ZCD 220 may be configured to identify zero current events, wherein ZCD 220 is configured to determine the positive current or the negative current at the low side of the low side power switch based on the zero crossing events

In a normal control scheme of power converter system 200 that operates low side switch 206B as an active diode, ZCD 220 may detect zero crossing events, and in response to zero crossing events, control logic 202 may change operation from CCM to DCM to achieve better efficiency. However, according to this disclosure, control logic 202 is configured to operate outside of the normal control scheme and in response to a load dump event in which current from the LC circuit (e.g., current on inductor 208 of the LC circuit that includes inductor 208 and capacitor 212) causes a negative load dump current that is detectable by ZCD 220. Control logic 202 is configured to control high side power switch 206A and low side power switch 206B such that the power converter system 200 is configured to operate in a forced CCM for a period of time associated with the load dump event prior to operating in the DCM. Unlike the normal control scheme, in forced CCM mode, current is allowed to go negative at ZCD 220 for a period of time sufficient to dissipate the load dump.

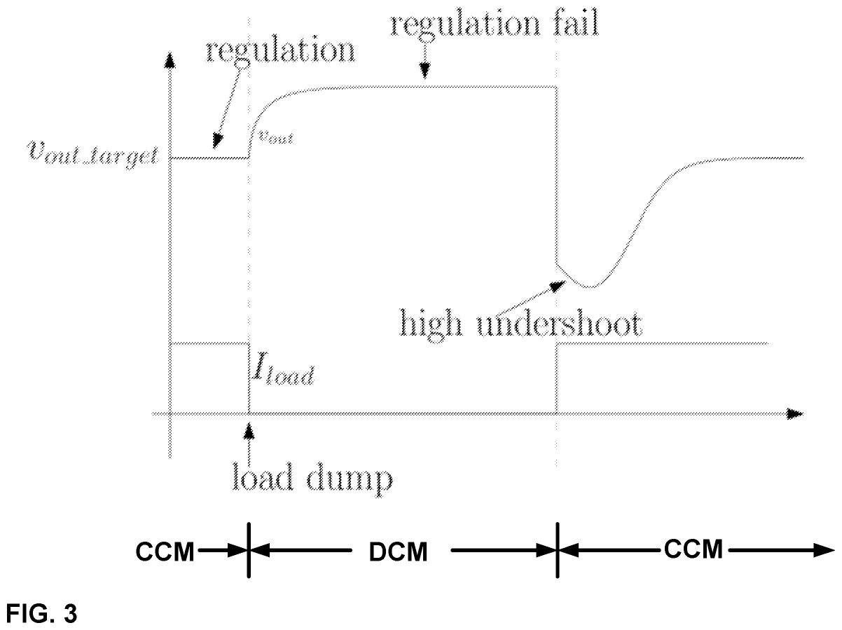

FIG. 3 is a set of graphs showing a load dump that may cause a regulation failure and high voltage undershoot, which the techniques of this disclosure may improve. As shown in FIG. 3, normal operation of a DC/DC power converter may cause a regulation failure in response to a load dump. In this case, the DC/DC power converter changes from CCM to DCM in response to the load dump, which causes a voltage overshoot during the DCM. Then, upon changing back to CCM mode, a high voltage undershoot occurs in the beginning of the next CCM mode. The regulation failure shown in FIG. 3 is unacceptable for some applications, such as for next generation microcontrollers like those summarized above.

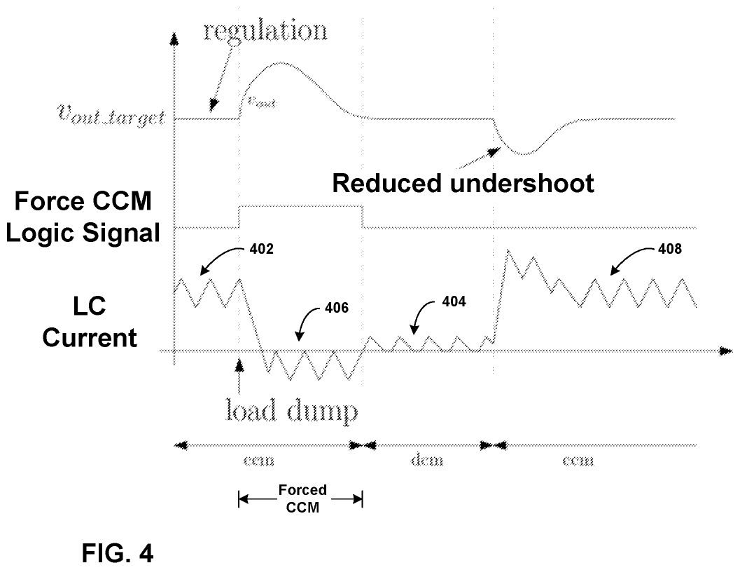

FIG. 4 is a set of graphs showing how a forced CCM according to this disclosure can improve upon the regulation failure and high voltage undershoot shown in FIG. 3. In this case, in response to a load dump event, a force CCM logic signal may cause control logic to operate outside of the normal operation scheme and in a so-called “forced CCM” where current is allowed to go negative to dissipate the load dump in a quick and efficient manner.

FIG. 4 shows that an LC current is configured to modulate between two or more first positive values, as shown in time period 402, when the power converter system operates in the CCM. For example, in time period 402, the LC current modulate between peaks and valleys that are all non-zero values. Moreover, the LC current is configured to modulate between one or more second positive values and a zero value, during time period 404, when the power converter system operates in the DCM. For example, in time period 406, the LC current modulate between peaks (positive values) and valleys (zero values).

After the CCM associated with time period 402 and before DCM associated with time period 404, the power converter system is forced to operate in a forced CCM mode, e.g., in time period 406. In the forced CCM mode, the LC current is configured to modulate between one or more negative values and one or more other values. For example, in time period 406, the LC current modulate between peaks (zero values) and valleys (negative values). After the DCM associated with time period 404, the power converter system may again operate in CCM during time period 408.

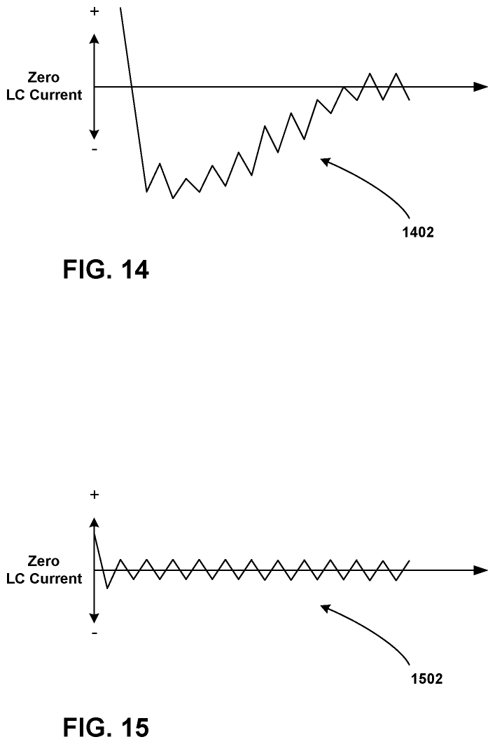

In the example shown in FIG. 4, during the forced CCM mode, the LC current is shown as modulating between one or more negative values (i.e., the valleys in time period 406) and zero values (i.e., the peaks during time period 406). However, in other cases, in forced CCM mode the LC current may modulate between different negative values (such as illustrated in FIG. 14, e.g., at 1402). For example, current may modulate between negative values until reaching steady state, where it then modulates between a positive value and a negative value. Also, as shown in FIG. 15, in forced CCM mode, current may modulate between a positive value and a negative value (such as illustrated in FIG. 15, e.g., at 1502). In normal CCM mode, with the active diode architecture, LC current is always positive to achieve efficiency. Unlike normal CCM mode with the active diode architecture, in forced CCM mode, LC current is allowed to go negative, in order to quickly and efficiently dissipate the load dump. The normal control scheme operating in CCM and DCM may be referred to herein as a first mode of operation, and the forced CCM may be referred to herein as a second mode of operation.

This disclosure describes several ways to identify a load dump. In some cases, the ZCD can detect any transient, the forced CCM mode can be applied following any detected transient. A transient generally occurs due to a load dump, but a transient may also occur from other events. Thus, in some examples, control logic 102, 202 may be configured to identify the load dump event based on the zero current events. Responding to a transient with a forced CCM mode for a period of time can ensure that the forced CCM mode is applied to every load dump event, but this may also cause forced CCM mode due to transients caused by something other than a load dump. This is generally acceptable for microcontrollers and any loss of efficiency is minimal. In other cases, load dumps can be detected by an error amplifier, e.g., as part of the control loop, or in other ways. Additional details of some examples are set forth below.

In some examples, when a load dump or another cause of a transient is detected, a transient detector signal is set. When the transient detector signal is set, the forced CCM is applied for a limited amount of time preventing the loop to get saturated. In steady state, then, the active diode functionality is restored ensuring high efficiency at low load. The approach can be used for any control loop (e.g., peak current loop, voltage mode or other types of control loops). In this example, a mere a logic change is all that may be required for the implementation, and this can achieve a 40% undershoot reduction in microcontroller applications

In other words, the control of a power converter may be forced to enter force CCM state during a load dump event, in order to keep the loop in regulation. Again, techniques may be applied, some examples, with the following features:
A converter able to work in CCM or in DCM
A transient detector; and
A logic circuit configured to force the CCM mode

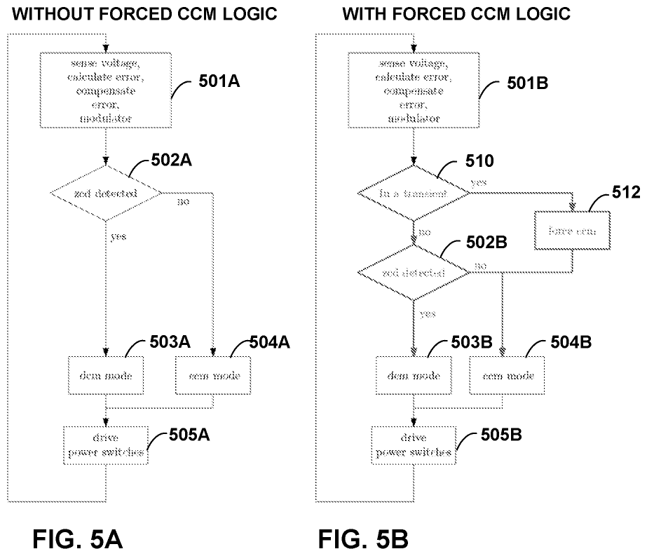

FIGS. 5A and 5B are flow diagrams showing a technique without a forced CCM (FIG. 5A) and a technique with a forced CCM (FIG. 5B). As shown in FIG. 5A, a power converter may include a control loop that senses voltage, calculates error, compensates for error, and modulates switches accordingly (501A). The system generally operates in CCM 504A (“no” 502A). However, in response to a zero current detection event (“yes” 502A), the system operates in DCM. The system drives power switches (505A) either according to CCM or DCM. Current generally remains positive on the LC circuit of the power converter.

In contrast to FIG. 5A, as shown in FIG. 5B, a power converter may include a forced CCM, in addition to CCM and DCM. In particular, as shown in FIG. 5B, a power converter may include a control loop that senses voltage, calculates error, compensates for error, and modulates switches accordingly (501B). The system generally operates in CCM 504A (“no” 510 and “no” 502B). However, in response to a transient (“yes” 510), the system operates in a forced CCM for a period of time that is sufficient to dissipate a load dump. If there is no transient (“no” 510) but there is a ZDC event (“yes” 502B) the system operates in DCM (503B). Also, following a sufficient time period in forced CCM, in response to a ZDC event (“yes” 502A), the system operates in DCM (503B). Of course, as noted above, in some examples, the ZDC circuit is used to identify a transient, in which case ZDC detection may cause the forced CCM to ensure that forced CCM occurs with every load dump, albeit possibly also causing forced CCM with other ZDC events that are not necessarily load dumps. The system drives power switches (505B) according to CCM, forced CCM, or DCM. Current generally remains positive on the LC circuit of the power converter in CCM and DCM, but current is allowed to go negative in the forced CCM.

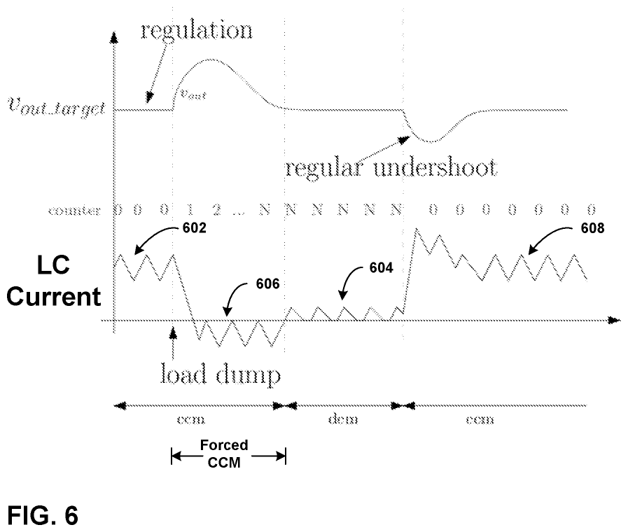

FIG. 6 is another set of graphs showing how a forced CCM according to this disclosure can improve upon the regulation failure and high voltage undershoot shown in FIG. 3. As with the example shown in FIG. 4, in the example of FIG. 6, in response to a load dump event, a force CCM logic signal may cause control logic to operate outside of the normal operation scheme and in a so-called “forced CCM” where current is allowed to go negative to dissipate the load dump in a quick and efficient manner. FIG. 6 adds the concept of a counter to define the amount of time sufficient to dissipate the load dump. In this case, control logic (e.g., 102 or 202) may include a counter that counts instances of negative current events. For example, a ZCD circuit (120 or 220) may count zero crossing events, and the control logic (e.g., 102 or 202) may be configured to change from the power converter system from the forced CCM to the DCM based on a count value. In particular, the control logic may be configured to change the power converter system from the forced CCM to the DCM based on the count value reaching N, where N is a positive integer greater than 3. Different values of N may be useful for different loads or different situations. In general, N should be defined to have sufficient time in forced CCM mode to ensure that any load dump has sufficient time to dissipate.

As with the example shown in FIG. 4, FIG. 6 shows that an LC current is configured to modulate between two or more first positive values, as shown in time period 602, when the power converter system operates in the CCM. For example, in time period 602, the LC current modulate between peaks and valleys that are all non-zero values. Moreover, the LC current is configured to modulate between one or more second positive values and a zero value, during time period 604, when the power converter system operates in the DCM. For example, in time period 606, the LC current modulate between peaks (positive values) and valleys (zero values).

After the CCM associated with time period 602 and before DCM associated with time period 604, the power converter system is forced to operate in a forced CCM mode, e.g., in time period 606. In the forced CCM mode, the LC current is configured to modulate between one or more negative values and one or more other values. For example, in time period 606, the LC current modulate between peaks (zero values) and valleys (negative values). After the DCM associated with time period 604, the power converter system may again operate in CCM during time period 608.

In the example shown in FIG. 6, during the forced CCM mode, the LC current is shown as modulating between one or more negative values (i.e., the valleys in time period 606) and zero values (i.e., the peaks during time period 606). However, again, in other cases, in forced CCM mode the LC current may modulate between different negative values (such as illustrated in FIG. 14, e.g., at 1402). For example, current may modulate between negative values until reaching steady state, where it then modulates between a positive value and a negative value. Also, as shown in FIG. 15, in forced CCM mode, current may modulate between a positive value and a negative value (such as illustrated in FIG. 15, e.g., at 1502). In normal CCM mode, with the active diode architecture, LC current is always positive to achieve efficiency. Unlike normal CCM mode with the active diode architecture, in forced CCM mode, LC current is allowed to go negative, in order to quickly and efficiently dissipate the load dump.

According to FIG. 6, the amount of time associated with period 606 where the forced CCM mode is applied may be based on a count value (or possibly a count sequence). In some examples, control logic of a power converter includes a counter that counts instances of negative current events, wherein the power converter circuit is configured to change from the forced CCM to the DCM based on a count value. Moreover, in some examples, the power converter system is configured to change from the forced CCM to the DCM based on the count value reaching N, where N is a positive integer greater than 3.

In some examples, a transient detector can be implemented as:
A sequence detector monitoring the zcd signal+counter
Transient start event: zcd signal 0→1, 00→1, 000→1
Transient end event: counter ends
   In other examples, a transient detector may be implemented as loop monitor that is part of the control loop, e.g., a dedicated circuit that monitor the status of the control loop.

Table 1 illustrates one example of a how transients may be defined to control a forced CCM mode that is responsive to any load dumps and sufficient to dissipate such load dumps.

TABLE 1

| | Offline | Online |
|---|---|---|
| Start transient | ZCD signal from 0 to 1 | With transient detector |
| | | circuit or ZCD signal |
| | | from 0 to 1 |
| End transient | Counter ends | With transient detector |
| | | circuit |

In some examples, a transient detector can be implemented as a sequence detector plus a counter. In this, case logic may include
a dead time circuit configured to define switch command signals (hs_on, ls_on); and
ZCD logic that is configured to turn off the low side switch if the current goes negative
   In this case, according to this disclosure, the logic can be modified by adding a circuit causes the logic to ignore the zed signal if the counter is running.

In some examples, a transient detector can be implemented a sequence detector plus analog counter. In this case, the counter may comprise an analog circuit that includes
A current generator
A capacitor
A switch to reset the voltage capacitor
A comparator; and
A voltage threshold Vth

In some examples, a loop monitor approach may be used to identify and respond to load dump events. For example, a loop monitor approach may implement a circuit configured to monitor the status of the error signal of the control loop. An error amplifier (EA) can be used for this purpose. In this case, in steady state, each branch of the EA brings half of the bias current. However, during a load dump, the current on one of the branches is higher than the other branch, and this information can be used to enable force CCM mode. For example, the error amplifier may be configured to send a force CCM logic signal to the control logic in response to mismatch of current ton the different branches of the EA.

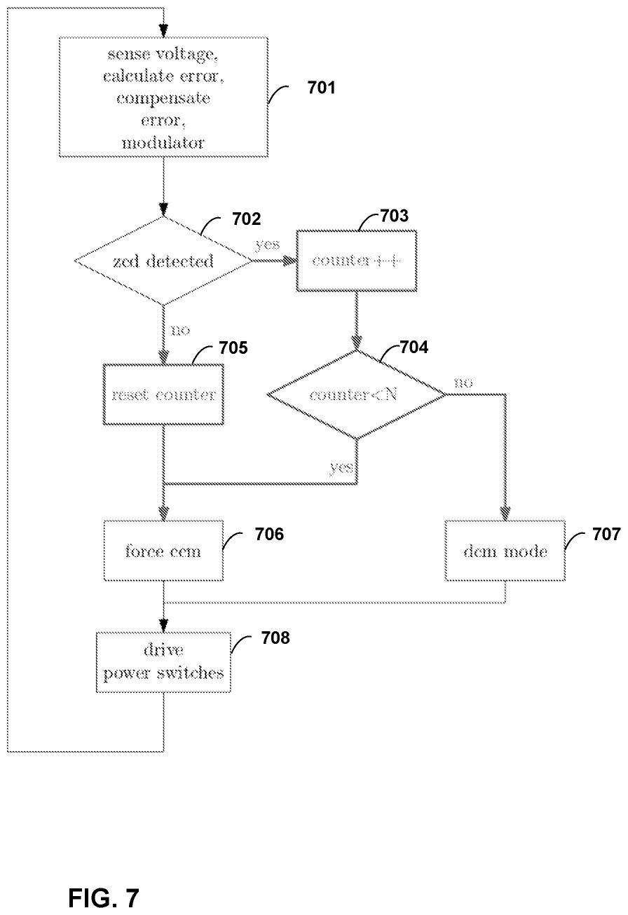

FIG. 7 is a flow diagram showing another technique consistent with this disclosure. In this example, a power converter may include a control loop that senses voltage, calculates error, compensates for error, and modulates switches accordingly (701). In response to a zero current detection event (“yes” 702), the system initiates a counter 703, and continues to count zero current crossing events until the counter reaches N (“no” 704). When the count value is less than N, (“yes” 704) the power converter system operates in forced CCM (706). When the count value reaches N (“no” 704), the power converter system operates in DCM (707). The system drives power switches (708) either according to forced CCM or DCM. Current generally remains positive on the LC circuit of the power converter in DCM, but current is allowed to go negative in CCM. FIG. 7 generally shows the process that follows a normal CCM. Instead of switching to DCM, following CCM, the system operates in a forced CCM until counter reaches N, at which time, the system operates in DCM. After operating in DCM, the system may then revert back to CCM, if and when current demands of the power converter increase.

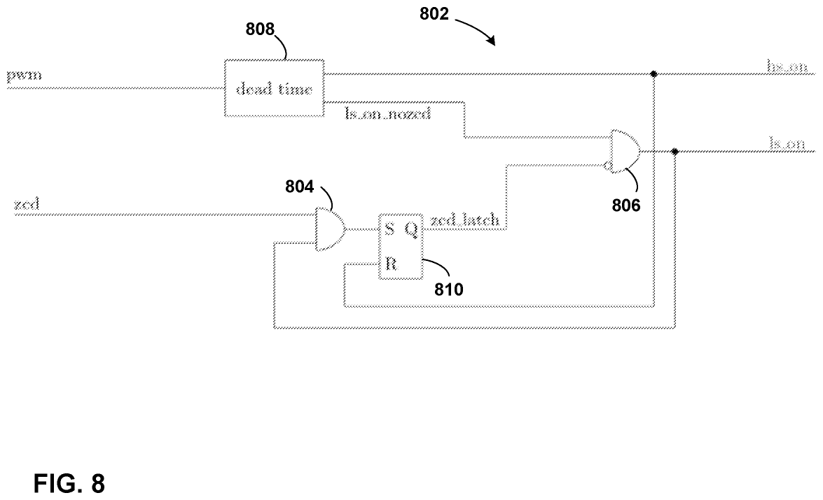

FIG. 8 is an example of some logic that may be used to high side and low side switches according to CCM and DCM based on pwm signals and zcd signals. In this case, logic 802 may include a comparator (first comparator 804) and a second comparator 806. Second comparator 806 may include an inverter on its lower input. Logic 802 also includes a dead time circuit 808 and a storage unit 810, e.g., a flip-flop. PWM signals are input to logic 802 and these PWM signals control high side and low side switches, following any dead time control of the low side and high side switches by dead time circuit 808. The output of second comparator 806 is fed back to the input of first comparator 804. First comparator 804 outputs a logic high when the low side switch is on and a ZCD event is detected. This causes the circuit to change from CCM mode to DCM mode in response to a zero current event. Dead time circuit 808 develops switch command signals (hs_on and ls_on), and ZDC logic that includes comparators 804, 806 and storage unit 810 is configured to turn off the low side switch if current goes negative, i.e., upon detecting a zero current crossing event.

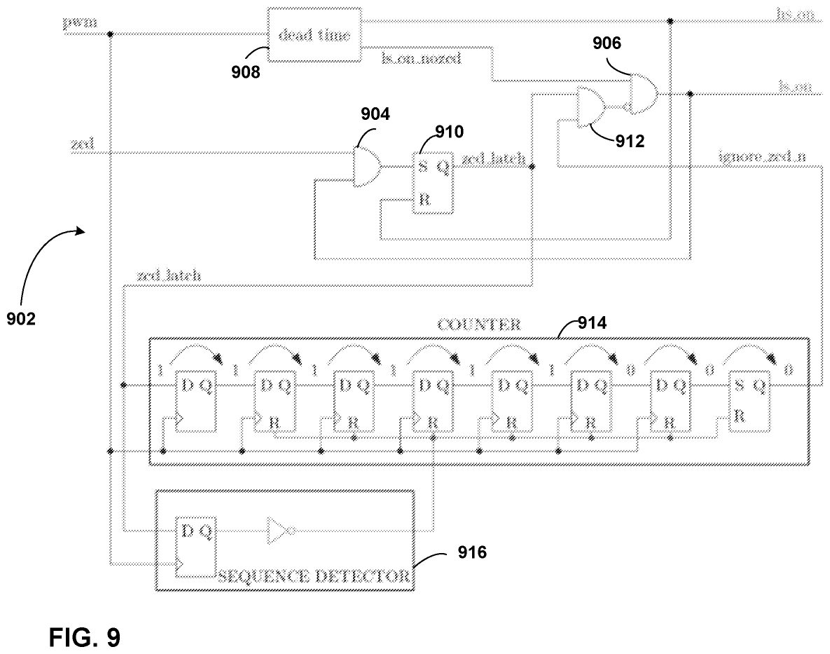

FIG. 9 is an example of logic that that is built upon the logic of FIG. 8, which may be used to control high side and low side switches according to CCM, DCM, and forced CCM based on pwm signals and zcd signals. In this case, like the logic of FIG. 8, logic 902 includes a first comparator 904, and a second comparator 906. Second comparator 906 includes an inverter on its lower input. Logic 902 also includes a dead time circuit 908 and a storage unit 910, e.g., a flip-flop. PWM signals are input to logic 902 and these PWM signals control high side and low side switches, following any dead time control of the low side and high side switches by dead time circuit 908. The output of second comparator 906 is fed back to the input of first comparator 904. First comparator 904 outputs a logic high when the low side switch is on and a ZCD event is detected. Logic 902 is modified relative to logic 802 by adding circuit elements (e.g., third comparator 912 and counter 914), which is configured to ignore the zcd signal if counter 914 is running. In addition, sequence detector 916 is configured to identify a sequence of counts, after which the zero current detection signal is used according to the normal control scheme. Thus, high side and low side switches are controlled according to CCM, DCM, and forced CCM based on pwm signals and zcd signals. Upon detecting a zcd signal, the logic switches from CCM to forced CCM for a period of counts of zcd signals, which is sufficient to dissipate any load dumps. Then, upon detecting a sequence of zcd signals, sequence detector 916 releases the latch of the zcd signal, causing logic 902 to change the control scheme from forced CCM to DCM. In some examples, control logic (e.g., 102, 202) is configured to change the power converter system from the forced CCM to the DCM based on sequence detector 916 detecting a particular sequence of the count value.

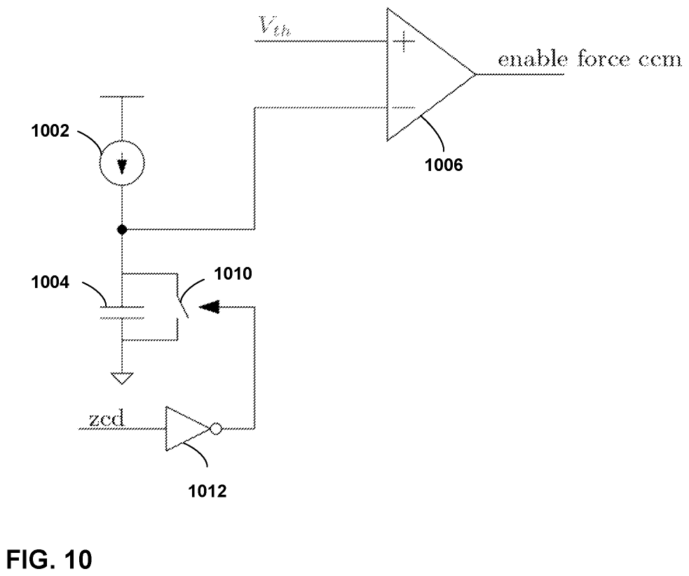

FIG. 10 is a circuit diagram showing an example analog circuit consistent with this disclosure. Analog circuit 1000 comprises a current generator 1002 and a capacitor 1004 arranged in series. The node between current generator 1002 and a capacitor 1004 is connected to comparator 1006. When a zcd signal is detected, the zcd signal is inverted by inverter 1012, causing switch 1010 to open. In other words, switch 1010 is closed when there is no zcd signal. Upon detecting a zcd signal, capacitor 1004 is charged until reaching a threshold. The forced ccm signal is output for a period of time associated with the charging of capacitor 1004 to reach Vth. In this way, a counter can be implemented in an analog circuit 1000 that includes current generator 1002, a capacitor 1004, a switch 1010 to reset the voltage on capacitor 1004, a comparator 1006, and voltage threshold Vth. Inverter 1012 is an implementation detail for controlling switch 1010 open or close according to the zcd signal.

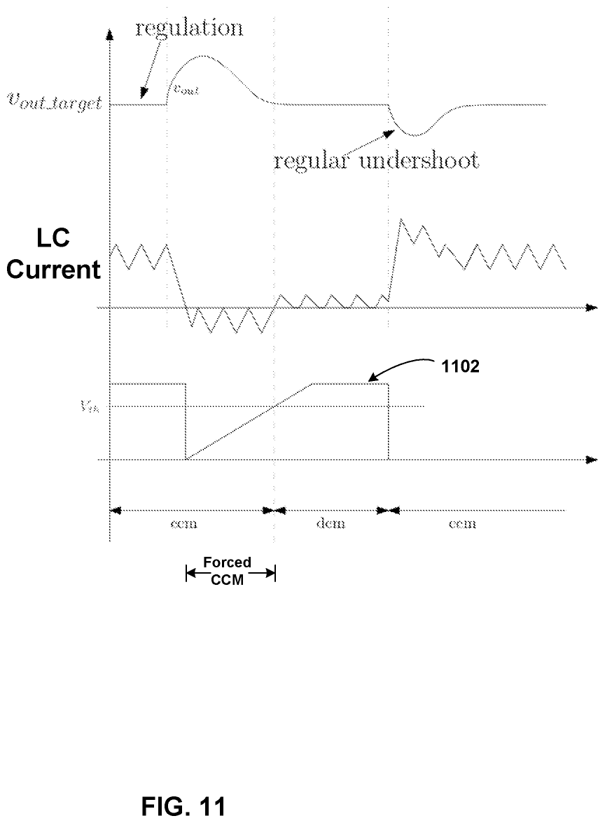

FIG. 11 is another set of graphs showing another example of a forced CCM according to an analog example of FIG. 10 that can improve upon the regulation failure and high voltage undershoot shown in FIG. 3. The LC current and voltage regulation shown in FIG. 11 is similar to that shown in the digital example of FIG. 4, so those details are not repeated here. The LC current shown in FIG. 11 operates in CCM, forced CCM, and DCM, just as with the example shown in FIG. 4. However, the analog control signal 1102 in FIG. 11 replaces the forced logic signal shown in FIG. 4 for analog control consistent with operation of circuit 1000 shown in FIG. 10.

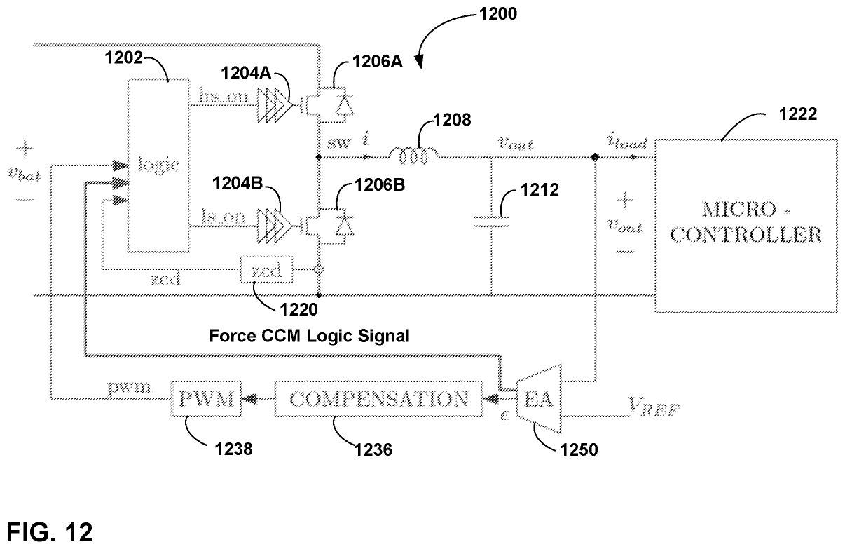

In still other examples, a loop monitor approach may be used to control the forced CCM. As shown in FIG. 12, in this case the main control loop of the power converter system 1200 can be modified to an error amplifier (EA) 1250 and logic 1202 can be configured to monitor status of EA 1250 for defining when to implement forced CCM.

In general, power converter system 1200 is similar to power converter system 200 in most respects, so many of the details will not be repeated here again. Logic 1202 is generally similar to logic 200, drivers 1204A, 1204B are similar to drivers 204A, 204B, switches 1206A, 1206B are similar to switches 206A, 206B, inductor 1208 is similar to inductor 1208, capacitor 1212 is similar to capacitor 212, microcontroller 1222 is similar to microcontroller 22, and ZDC 1220 is similar to ZDC 220. In the control loop, PWM generator 1238 is similar to PWM generator 238, and compensation circuit 1236 is similar to compensation circuit 236. Unlike FIG. 2, as shown in FIG. 12, the main control loop of the power converter system 1200 is modified to include EA 1250 and logic 1202 can be configured to monitor status of EA 1250 for defining when to implement forced CCM. Like other examples herein, power converter system 1200 is configured to implement a forced CCM, when necessary to dissipate a load dump. In this case, power converter system further comprises a regulation control loop, wherein the regulation control loop includes EA 1250 configured to output a force_CCM_logic signal to control logic 1202 in response to detecting the load dump event.

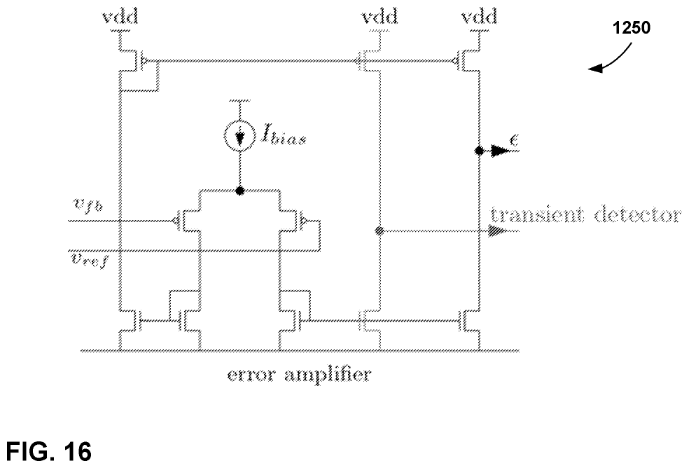

FIG. 16 is a circuit diagram showing one example of an error amplifier (EA) 1250. In steady state each branch of EA 1250 brings half of the bias current. During a load dump the current on the right branch is higher and this information can be used to enable force_ccm mode.

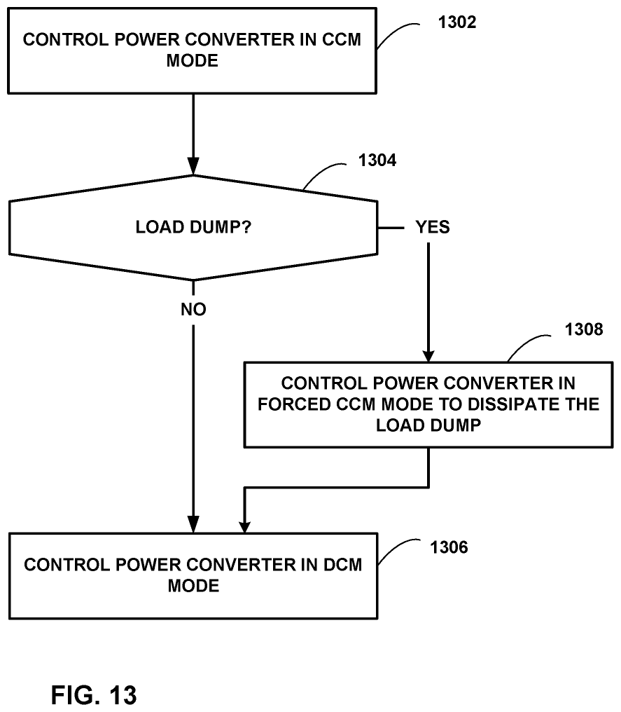

FIG. 13 is a flow diagram consistent with one or more techniques of this disclosure. FIG. 13 shows one example method of controlling a power converter system that includes a high side power switch, a low side power switch connected to the high side power switch at a switch node, an inductor-capacitor (LC) circuit connected to the switch node, and a detector connected to a low side of the low side power switch. As shown in FIG. 13, the method may comprise controlling the power converter in a CCM mode 1302, which may include controlling the high side power switch and the low side power switch according to a control scheme such that the power converter system is configured to operate in a CCM in response to determining a positive current on the low side of the low side power switch. The method may also include controlling the power converter in a DCM (“no” 1304, 1306), which may include controlling the high side power switch and the low side power switch according to the control scheme such that the power converter system is configured to operate in a in response to determining a negative current on the low side of the low side power switch. Moreover, in response to a load dump event (“yes” 1304), the method may comprise controlling the power converter system in a forced CCM to dissipate the load dump (1308). In particular, in response to a load dump event (“yes” 1304) in which current from the LC circuit causes a negative load dump current at the detector, step 1308 of the method shown in FIG. 13 may comprise controlling the high side power switch and the low side power switch such that the power converter is configured to operate in a forced CCM for a period of time associated with the load dump event prior to operating in the DCM.

This disclosure has attributed functionality to control logic 102, 202, 1202, each of which may include processing circuitry such as one or more processors. Control logic 102, 202, 1202 and any other functional elements described herein may include any combination of integrated circuitry, discrete logic circuitry, analog circuitry, such as one or more microprocessors, digital signal processors (DSPs), application specific integrated circuits (ASICs), and/or field-programmable gate arrays (FPGAs). In some examples, control logic 102, 202, 1202 may include multiple components, such as any combination of one or more microprocessors, one or more DSPs, one or more ASICs, or one or more FPGAs, as well as other discrete or integrated logic circuitry, and/or analog circuitry.

As an illustrative example of a power converter system 200, 1200 connected to a microcontroller 22, 1222, microcontroller may be configured to operate in a first microcontroller mode and a second microcontroller mode, wherein the first microcontroller mode requires more current than the second microcontroller mode. The second microcontroller mode, for example, may comprise a low power mode, a standby mode, or any mode that requires less current than the first microcontroller mode When microcontroller 22, 1222 is operating in the first microcontroller mode, the power converter power converter system 200, 1200 may operate in a first power converter mode, which may include CCM and possibly DCM. However, in response to the microcontroller 22, 1222 switching from the first microcontroller mode to the second microcontroller mode, power converter system 200, 1200 may operate in a second mode, which includes a forced CCM (such as described herein) to quickly and effectively dissipate any load dump, which may be caused by the microcontroller changing from the first microcontroller mode to the second microcontroller mode.

The techniques described in this disclosure may also be encoded in instructions and data stored to a non-transitory computer-readable storage medium, such as memory associated with control logic 102, 202, 1202. In this case, the instructions may be executed by one or more processors, e.g., control logic 102, 202, 1202. Example non-transitory computer-readable storage media may include RAM, ROM, programmable ROM (PROM), erasable programmable ROM (EPROM), electronically erasable programmable ROM (EEPROM), flash memory, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

The following numbered aspects demonstrate one or more clauses of the disclosure.

Clause 1—A power converter system comprising: a high side power switch; a low side power switch connected to the high side power switch at a switch node; an LC circuit connected to the switch node; a detector connected to a low side of the low side power switch; and control logic configured to control the high side power switch and the low side power switch according to a control scheme in which the power converter system is configured to operate in a CCM in response to determining a positive current on the low side of the low side power switch and operate in a DCM in response to determining a negative current on the low side of the low side power switch, wherein in response to a load dump event in which current from the LC circuit causes a negative load dump current at the detector, the control logic is further configured to control the high side power switch and the low side power switch such that the power converter system is configured to operate in a forced CCM for a period of time associated with the load dump event prior to operating in the DCM.

Clause 2—The power converter system of clause 1, wherein: an LC current is configured to modulate between two or more first positive values in the CCM; the LC current is configured to modulate between one or more second positive values and a zero value in the DCM; and the LC current is configured to modulate between one or more negative values and one or more other values in the forced CCM.

Clause 3—The power converter system of clause 1 or 2, wherein the power converter system is configured to regulate the switch node between approximately 0.7 and 1.2 volts with output current greater than approximately 5 amps.

Clause 4—The power converter system of any of clauses 1-3, wherein the control logic includes a counter that counts instances of negative current events, wherein the power converter circuit is configured to change from the forced CCM to the DCM based on a count value.

Clause 5—The power converter system of clause 4, wherein the wherein the power converter system is configured to change from the forced CCM to the DCM based on the count value reaching N, where N is a positive integer greater than 3.

Clause 6—The power converter system of clause 4, further comprising a sequence detector, wherein the power converter system is configured to change from the forced CCM to the DCM based on the sequence detector detecting a particular sequence of the count value.

Clause 7—The power converter system of any of clauses 1-6, wherein the detector comprises a zero current detector circuit that identifies zero current events, wherein the detector is configured to determine the positive current or the negative current at the low side of the low side power switch based on the zero crossing events

Clause 8—The power converter of clause 7, wherein the control logic is configured to identify the load dump event based on the zero current events.

Clause 9—The power converter system of any of clauses 1-3, wherein the power converter system further comprises a regulation control loop, wherein the regulation control loop includes an error amplifier configured to output a force_CCM_logic signal to the control logic in response to detecting the load dump event.

Clause 10—A circuit configured to control a power converter system that includes a high side power switch, a low side power switch connected to the high side power switch at a switch node, an LC circuit connected to the switch node, and a detector connected to a low side of the low side power switch, wherein the circuit comprises: control logic configured to control the high side power switch and the low side power switch according to a control scheme in which the power converter system is configured to operate in a CCM in response to determining a positive current on the low side of the low side power switch and operate in a DCM in response to determining a negative current on the low side of the low side power switch, wherein in response to a load dump event in which current from the LC circuit causes a negative load dump current at the detector, the control logic is further configured to control the high side power switch and the low side power switch such that the power converter system is configured to operate in a forced CCM for a period of time associated with the load dump event prior to operating in the DCM.

Clause 11—The circuit of clause 10, wherein the circuit comprises one or more drivers configured to provide PM signals to the low side power switch and the high side power switch based on control signals from the control logic.

Clause 12—The circuit of clause 10 or 11, wherein: an LC current is configured to modulate between two or more first positive values in the CCM; the LC current is configured to modulate between one or more second positive values and a zero value in the DCM; and the LC current is configured to modulate between one or more negative values and one or more other values in the forced CCM.

Clause 13—The circuit of clause 10 or 11, wherein the power converter system configured to regulate the switch node between approximately 0.7 and 1.2 volts with output current greater than approximately 5 amps.

Clause 14—The circuit of any of clauses 10-13, wherein the control logic includes a counter that counts instances of negative current events, wherein the control logic is configured to change from the power converter system from the forced CCM to the DCM based on a count value.

Clause 15—The circuit of clause 14, wherein the wherein the control logic is configured to change the power converter system from the forced CCM to the DCM based on the count value reaching N, where N is a positive integer greater than 3.

Clause 16—The circuit of clause 14, further comprising a sequence detector, wherein the control logic is configured to change the power converter system from the forced CCM to the DCM based on the sequence detector detecting a particular sequence of the count value.

Clause 17—The circuit of any of clauses 1-16, wherein the detector of the power converter system comprises a zero current detector circuit that identifies zero current events, wherein the detector is configured to determine the positive current or the negative current at the low side of the low side power switch based on the zero crossing events.

Clause 18—The circuit of clause 17, wherein the control logic is configured to identify the load dump event based on the zero current events.

Clause 19—The circuit of any of clauses 10-13, wherein the power converter system further comprises a regulation control loop, wherein the regulation control loop includes an error amplifier configured to output a force_CCM_logic signal to the control logic in response to detecting the load dump event.

Clause 20—A method of controlling a power converter system that includes a high side power switch, a low side power switch connected to the high side power switch at a switch node, an LC circuit connected to the switch node, and a detector connected to a low side of the low side power switch, the method comprising: controlling the high side power switch and the low side power switch according to a control scheme such that the power converter system is configured to operate in a CCM in response to determining a positive current on the low side of the low side power switch; controlling the high side power switch and the low side power switch according to the control scheme such that the power converter system is configured to operate in a DCM in response to determining a negative current on the low side of the low side power switch; and in response to a load dump event in which current from the LC circuit causes a negative load dump current at the detector, controlling the high side power switch and the low side power switch such that the power converter is configured to operate in a forced CCM for a period of time associated with the load dump event prior to operating in the DCM.

Various devices, circuits, methods, and features have been described in this disclosure. These and other devices, circuits, methods and features are within the scope of the following claims.

What is claimed is:

1. A power converter system comprising:
a high side power switch;
a low side power switch connected to the high side power switch at a switch node;
an inductor-capacitor (LC) circuit connected to the switch node;
a detector connected to a low side of the low side power switch; and
control logic configured to control the high side power switch and the low side power switch according to a control scheme in which the power converter system is configured to operate in a continuous conduction mode (CCM) in response to determining a positive current on the low side of the low side power switch and operate in a discontinuous conduction mode (DCM) in response to determining a negative current on the low side of the low side power switch,
wherein in response to a load dump event in which current from the LC circuit causes a negative load dump current at the detector, the control logic is further configured to control the high side power switch and the low side power switch such that the power converter system is configured to operate in a forced CCM for a period of time associated with the load dump event prior to operating in the DCM.

2. The power converter system of claim 1, wherein:
an LC current is configured to modulate between two or more first positive values in the CCM;
the LC current is configured to modulate between one or more second positive values and a zero value in the DCM; and
the LC current is configured to modulate between one or more negative values and one or more other values in the forced CCM.

3. The power converter system of claim 1, wherein the power converter system is configured to regulate the switch node between approximately 0.7 and 1.2 volts with output current greater than approximately 5 amps.

4. The power converter system of claim 1, wherein the control logic includes a counter that counts instances of negative current events, wherein the power converter circuit is configured to change from the forced CCM to the DCM based on a count value.

5. The power converter system of claim 4, wherein the power converter system is configured to change from the forced CCM to the DCM based on the count value reaching N, wherein N is a positive integer greater than 3.

6. The power converter system of claim 4, further comprising a sequence detector, wherein the power converter system is configured to change from the forced CCM to the DCM based on the sequence detector detecting a particular sequence of the count value.

7. The power converter of claim 1, wherein the detector comprises a zero current detector circuit that identifies zero current events, wherein the detector is configured to determine the positive current or the negative current at the low side of the low side power switch based on the zero crossing events.

8. The power converter of claim 7, wherein the control logic is configured to identify the load dump event based on the zero current events.

9. The power converter of claim 1, wherein the power converter system further comprises a regulation control loop, wherein the regulation control loop includes an error amplifier configured to output a force_CCM_logic signal to the control logic in response to detecting the load dump event.

10. A circuit configured to control a power converter system that includes a high side power switch, a low side power switch connected to the high side power switch at a switch node, an inductor-capacitor (LC) circuit connected to the switch node, and a detector connected to a low side of the low side power switch, wherein the circuit comprises:
control logic configured to control the high side power switch and the low side power switch according to a control scheme in which the power converter system is configured to operate in a continuous conduction mode (CCM) in response to determining a positive current on the low side of the low side power switch and operate in a discontinuous conduction mode (DCM) in response to determining a negative current on the low side of the low side power switch,
wherein in response to a load dump event in which current from the LC circuit causes a negative load dump current at the detector, the control logic is further configured to control the high side power switch and the low side power switch such that the power converter system is configured to operate in a forced CCM for a period of time associated with the load dump event prior to operating in the DCM.

11. The circuit of claim 10, wherein the circuit comprises one or more drivers configured to provide pulse modulation (PM) signals to the low side power switch and the high side power switch based on control signals from the control logic.

12. The circuit of claim 10, wherein:
an LC current is configured to modulate between two or more first positive values in the CCM;
the LC current is configured to modulate between one or more second positive values and a zero value in the DCM; and
the LC current is configured to modulate between one or more negative values and one or more other values in the forced CCM.

13. The circuit of claim 10, wherein the power converter system is configured to regulate the switch node between approximately 0.7 and 1.2 volts with output current greater than approximately 5 amps.

14. The circuit of claim 10, wherein the control logic includes a counter that counts instances of negative current events, wherein the control logic is configured to change from the power converter system from the forced CCM to the DCM based on a count value.

15. The circuit of claim 14, wherein the control logic is configured to change the power converter system from the forced CCM to the DCM based on the count value reaching N, where N is a positive integer greater than 3.

16. The circuit of claim 14, further comprising a sequence detector, wherein the control logic is configured to change the power converter system from the forced CCM to the DCM based on the sequence detector detecting a particular sequence of the count value.

17. The circuit of claim 10, wherein the detector of the power converter system comprises a zero current detector circuit that identifies zero current events, wherein the detector is configured to determine the positive current or the negative current at the low side of the low side power switch based on the zero crossing events.

18. The circuit of claim 17, wherein the control logic is configured to identify the load dump event based on the zero current events.

19. The circuit of claim 10, wherein the power converter system further comprises a regulation control loop, wherein the regulation control loop includes an error amplifier configured to output a force_CCM_logic signal to the control logic in response to detecting the load dump event.

20. A method of controlling a power converter system that includes a high side power switch, a low side power switch connected to the high side power switch at a switch node, an inductor-capacitor (LC) circuit connected to the switch node, and a detector connected to a low side of the low side power switch, the method comprising:
controlling the high side power switch and the low side power switch according to a control scheme such that the power converter system is configured to operate in a continuous conduction mode (CCM) in response to determining a positive current on the low side of the low side power switch;
controlling the high side power switch and the low side power switch according to the control scheme such that the power converter system is configured to operate in a discontinuous conduction mode (DCM) in response to determining a negative current on the low side of the low side power switch; and
in response to a load dump event in which current from the LC circuit causes a negative load dump current at the detector, controlling the high side power switch and the low side power switch such that the power converter is configured to operate in a forced CCM for a period of time associated with the load dump event prior to operating in the DCM.
